(19) United States
(12) Patent Application Publication
(10) Pub. No.: US 2026/0003547 A1
(43) Pub. Date: Jan. 1, 2026

(54) IMAGE PROCESSING APPARATUS, PROCESSING METHOD, AND NON-TRANSITORY COMPUTER-READABLE STORAGE MEDIUM STORING PROGRAM

(71) Applicant: SEIKO EPSON CORPORATION, TOKYO (JP)

(72) Inventor: Akio TAKAMOTO, SHIOJIRI-SHI (JP)

(21) Appl. No.: 19/251,807

(22) Filed: Jun. 27, 2025

(30) Foreign Application Priority Data
Jun. 28, 2024 (JP) 2024-104912

(51) Int. Cl. G06F 3/12

(52) U.S. Cl. CPC G06F 3/1205; G06F 3/1258; G06F 3/1292

(57) ABSTRACT

An image processing apparatus includes a printing unit configured to perform printing, a communication unit configured to perform wireless communication, and a page processing section configured to perform a process of displaying a setting page for setting the image processing apparatus on a terminal device. The page processing section is configured to perform the process after the communication unit establishes a wireless connection with the terminal device, when the printing unit is in a printable state, and not to perform the process when the printing unit is not in the printable state.

The present application is based on, and claims priority from JP Application Serial Number 2024-104912, filed Jun. 28, 2024, the disclosure of which is hereby incorporated by reference herein in its entirety.

### BACKGROUND

### 1. Technical Field

The present disclosure relates to an image processing apparatus, a processing method, and a non-transitory computer-readable storage medium storing a program.

### 2. Related Art

Techniques for connecting a device to a wireless network are known. For example, JP-A-2024-007648 discloses that a terminal device directly connects to an image processing apparatus in order for setting, using the terminal device, for connecting the image processing apparatus to the wireless network.

In a case where the terminal device and the image processing apparatus are directly connected to each other, it is not necessary to use a wired cable for communication between the terminal device and the image processing apparatus, which improves user convenience. However, when the terminal device establishes a direct connection with the image processing apparatus, a browser may be activated on the terminal device and a predetermined page may be displayed. Such an operation on the terminal device is convenient for a user who wants to perform the setting of the image processing apparatus by using the browser, but is inconvenient for a user who wants to perform the setting of the image processing apparatus without using the browser. For example, in a case where the setting of the image processing apparatus is performed using an application installed on the terminal device, an unnecessary browser is activated, which may confuse the user or interfere with the execution of the application.

### SUMMARY

An image processing apparatus according to the present disclosure includes a printing unit configured to perform printing, a communication unit configured to perform wireless communication, and a page processing section configured to perform a process of displaying a setting page for setting the image processing apparatus on a terminal device. The page processing section is configured to perform the process after the communication unit establishes a wireless connection with the terminal device, when the printing unit is in a printable state, and not to perform the process when the printing unit is not in the printable state.

A processing method according to the present disclosure is for an image processing apparatus including a printing unit configured to perform printing and a communication unit configured to perform wireless communication. The processing method includes determining whether the printing unit is in a printable state, performing a process of displaying a setting page for setting the image processing apparatus on a terminal device after the communication unit establishes a wireless connection with the terminal device, when the printing unit is in the printable state, and not performing the process when the printing unit is not in the printable state.

A non-transitory computer-readable storage medium according to the present disclosure stores a program causing a computer of an image processing apparatus including a printing unit configured to perform printing and a communication unit configured to perform wireless communication to execute determining whether the printing unit is in a printable state, performing a process of displaying a setting page for setting the image processing apparatus on a terminal device after the communication unit establishes a wireless connection with the terminal device, when the printing unit is in the printable state, and not performing the process when the printing unit is not in the printable state.

### BRIEF DESCRIPTION OF THE DRAWINGS

FIG. 1 is a schematic diagram for explaining a configuration example of a system including an image processing apparatus and a terminal device according to an embodiment.

FIG. 2 is a block diagram illustrating an example of the configuration of the image processing apparatus according to the first embodiment.

FIG. 3 is a diagram illustrating an example of printing by a printing unit.

FIG. 4 is a block diagram illustrating an example of a configuration of a terminal device according to an embodiment.

FIG. 5 is a schematic diagram illustrating an example of a screen displayed on the UI unit by the setting application.

FIG. 6 is a schematic diagram illustrating an example of a screen displayed on the UI unit by the setting application.

FIG. 7 is a flowchart illustrating an example of processing flow of the image processing apparatus according to the first embodiment.

FIG. 8 is a diagram illustrating an example of printing by a printing unit.

FIG. 9 is a block diagram illustrating an example of a configuration of an image processing apparatus according to a second embodiment.

FIG. 10 is a flowchart illustrating an example of a process flow of the image processing apparatus according to the second embodiment.

FIG. 11 is a diagram illustrating an example of printing by a printing unit.

FIG. 12 is a flowchart illustrating an example of a process flow of an image processing apparatus according to a variant of the second embodiment.

FIG. 13 is a flowchart illustrating an example of a process flow of an image processing apparatus according to a third embodiment.

FIG. 14 is a block diagram illustrating an example of a hardware configuration of a computer.

### DESCRIPTION OF EMBODIMENTS

Hereinafter, embodiments and the like will be described with reference to the drawings. For the sake of clarity, the following description and drawings are appropriately omitted and simplified. In each drawing, the same elements are denoted by the same references, and redundant description thereof will be omitted as appropriate. In addition, not all of the features or steps shown in any one of the figures to describe exemplary embodiments are necessarily essential, and some features or steps may be omitted. Furthermore, the order of the steps described in any of the figures may be changed as appropriate.

### First Embodiment

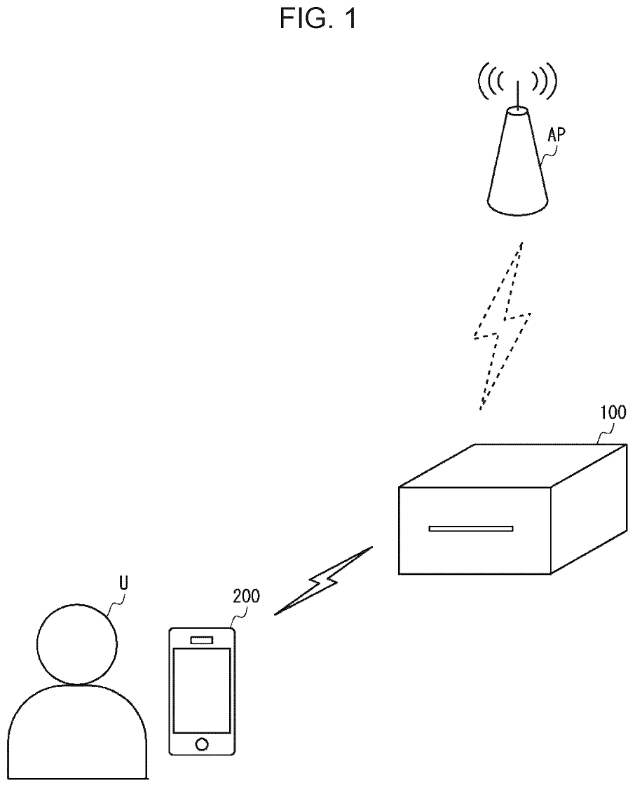

FIG. 1 is a schematic diagram illustrating a configuration example of a system including an image processing apparatus and a terminal device according to an embodiment. The user U performs a setting of the image processing apparatus 100 by using a terminal device 200. For example, a user U performs a setting for connecting the image processing apparatus 100 to an access point AP of a wireless network, but the present disclosure is not limited thereto, and the user U may perform a setting of an arbitrary function (for example, a printing function) of the image processing apparatus 100. In order for setting the image processing apparatus 100 using the terminal device 200, the terminal device 200 and the image processing apparatus 100 need to be connected so as to be able to communicate with each other. Therefore, in the present embodiment, the terminal device 200 and the image processing apparatus 100 establish a wireless direct connection and communicate with each other.

The image processing apparatus 100 of the present embodiment is, for example, a receipt printer for printing register information such as sales data on a receipt as a medium. Since receipt printers are small, they do not have a sufficient user interface (UI) in many cases, and it is difficult to perform setting by directly operating the image processing apparatus 100. Therefore, it is required to perform the setting using the terminal device 200. The image processing apparatus 100 is not limited to a receipt printer, and may be any printer. The image processing apparatus 100 is not limited to a printer, and may be any electronic apparatus such as a scanner, a projector, or a personal computer. In addition, the printer mentioned here includes a multifunction printer. The multifunction printer refers to a printer including functions other than a printer function, and the functions other than the printer function include a copy function, a facsimile function, a scanner function, and the like, but may be other functions.

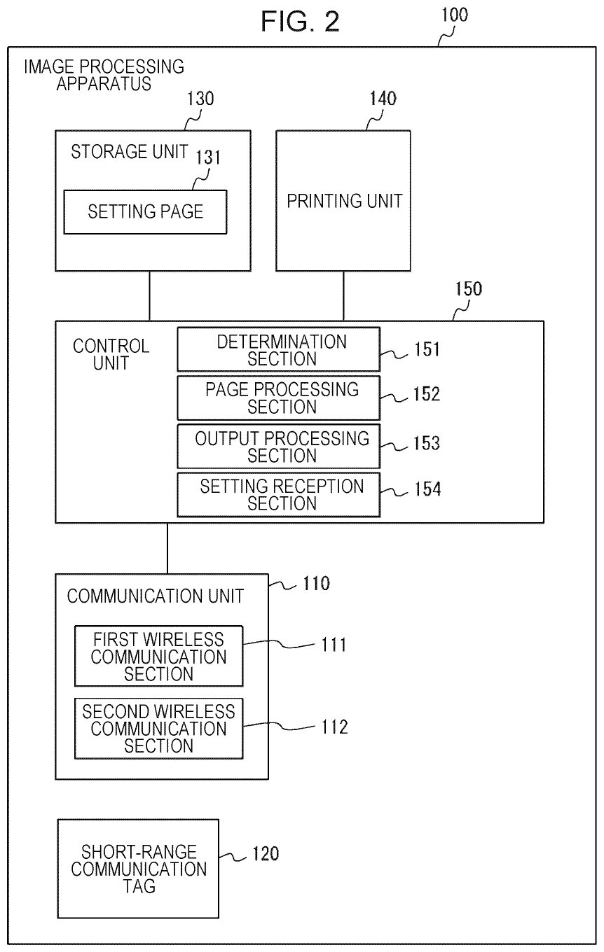

FIG. 2 is a block diagram illustrating an example of a configuration of the image processing apparatus 100. As illustrated in FIG. 2, the image processing apparatus 100 includes a communication unit 110, a short-range communication tag 120, a storage unit 130, a printing unit 140, and a control unit 150.

The communication unit 110 is a hardware circuit that performs wireless communication with another apparatus according to a predetermined communication standard, and may include software such as firmware. The communication unit 110 includes a first wireless communication section 111 and a second wireless communication section 112.

The first wireless communication section 111 is a circuit that performs communication according to a first wireless communication standard. Specifically, the first wireless communication section 111 performs wireless communication according to the Wi-Fi (registered trademark) standard. In the present embodiment, the first wireless communication section 111 performs wireless communication according to the Wi-Fi Direct (registered trademark) standard. Wi-Fi Direct is a specific example of direct connection in the present disclosure. The first wireless communication section 111 operates as an internal access point that is a software access point when performing communication according to the Wi-Fi Direct standard. Moreover, the first wireless communication section 111 performs wireless communication in an infrastructure mode defined by the Wi-Fi standard. In other words, the first wireless communication section 111 performs wireless communication with the access point AP. However, in order to realize this, it is necessary for the image processing apparatus 100 to have appropriate setting regarding the network. In the present embodiment, the user U performs this setting using the terminal device 200 directly connected to the image processing apparatus 100.

The second wireless communication section 112 is a circuit that performs communication according to the second wireless communication standard. Specifically, the second wireless communication section 112 performs wireless communication according to the BLE (Bluetooth Low Energy) standard, which is a power saving standard of Bluetooth (registered trademark). More specifically, the second wireless communication section 112 transmits a BLE beacon that complies with the BLE standard. In the present embodiment, as will be described later, the second wireless communication section 112 transmits a BLE beacon including connection information required for the terminal device 200 to establish a direct connection with the image processing apparatus 100.

The short-range communication tag 120 is an IC (integrated circuit) chip in which information readable by short-range communication is stored. In the present embodiment, specifically, the short-range communication tag 120 is a tag conforming to the near field communication (NFC) standard. The short-range communication tag 120 stores connection information required for the terminal device 200 to establish a direct connection with the image processing apparatus 100.

Although the image processing apparatus 100 shown in FIG. 2 includes both the second wireless communication section 112 and the short-range communication tag 120, the image processing apparatus 100 may include only one of them. In the present embodiment, as described above, both the second wireless communication section 112 and the short-range communication tag 120 are used for the terminal device 200 to acquire connection information necessary for the terminal device 200 to establish a direct connection with the image processing apparatus 100.

The storage unit 130 is any storage device that stores a setting page 131. The storage unit 130 may be realized by a memory 902 to be described later. The setting page 131 is page data that can be viewed by a browser installed in an external device such as the terminal device 200. Therefore, the user U can view the setting page 131 via a browser 252 (to be described later) of the terminal device 200. In this embodiment, the setting page 131 includes a GUI (Graphical User Interface) component for inputting network settings. The GUI component on the setting page 131 may be any component capable of receiving an input from the user. For example, the GUI component may be a component (for example, an input box) which receives a free input from the user, or may be a component (for example, a radio button) which receives a selection from options. In the present embodiment, the network setting that can be designated on the setting page 131 includes a setting for connecting the image processing apparatus 100 to the access point AP of the wireless network. Specifically, the network settings which can be designated on the setting page 131 include a setting of a security type in wireless communication, a setting of a frequency used for wireless communication, and the like in addition to a setting of a SSID (service set identifier) and a password of an access point to be connected. Further, the network setting that can be designated using the setting page 131 may be a setting of an IP (Internet Protocol) address, a subnet mask, and a gateway to be set in the image processing apparatus 100, or may be a setting of whether to use a DHCP (Dynamic Host Configuration Protocol) server. However, these are merely examples of settings that can be designated on the setting page 131, and the setting page 131 may not be able to designate all of these settings. Further, the setting page 131 may be capable of designating a setting of any function of the image processing apparatus 100. For example, the setting page 131 may be capable of designating settings of printing conditions (for example, printing density, printing speed) of the printing unit 140 to be described later. In this way, the user U can perform various settings related to the image processing apparatus 100 via the terminal device 200 by performing an input operation on the setting page 131 displayed by the browser 252, which will be described later, of the terminal device 200.

The printing unit 140 includes a print engine that is a mechanical configuration for executing printing of an image on a medium set in the image processing apparatus 100. The print engine includes, for example, a transport mechanism, an ink jet type of ejection head, and a drive mechanism of a carriage including the ejection head. The printing unit 140 prints an image on the medium by ejecting ink from the ejection head onto the medium transported by the transport mechanism. In the present embodiment, as an example, the medium set in the image processing apparatus 100 is a receipt paper, but it is not limited to the receipt paper, and may be any paper or a medium such as a cloth. The medium on which printing is performed may be referred to as a printing medium or a recording medium. The printing unit 140 may include a print engine configured to perform printing with toner by an electrophotographic method.

The control unit 150 controls the operation of the image processing apparatus 100. In the present embodiment, the control unit 150 has a captive portal function for a user who performs the setting of the image processing apparatus 100 using a browser. As is generally known, the captive portal function is a function for displaying a predetermined page on a partner device with which a communication connection has been established. In the present embodiment, the captive portal function is a function for displaying the setting page 131 on the browser 252 of the terminal device 200 that has established a wireless connection with the image processing apparatus 100. In other words, the control unit 150 has a function for displaying the setting page 131 on the browser 252 of the terminal device 200. The captive portal function may be referred to as a page guidance function.

Since the captive portal function allows the setting page 131 to be displayed on the browser 252 of the terminal device 200 after the wireless connection between the image processing apparatus 100 and the terminal device 200 is established, it is convenient for the user who wants to perform the setting of the image processing apparatus 100 using the browser 252. However, this function is inconvenient for a user who wants to perform the setting of the image processing apparatus 100 without using the browser 252, i.e., a user who wants to perform the setting of the image processing apparatus 100 using a setting application 253 (to be described later) of the terminal device 200. This is because the activation of the browser 252 unnecessary for the setting confuses the user or hinders the execution of the setting application 253. Therefore, in the present embodiment, the above-described captive portal function is enabled or disabled according to a predetermined condition. Thus, the image processing apparatus 100 improves the convenience of the user U.

In the present embodiment, as will be described later, the setting application 253 acquires connection information required for the terminal device 200 to wirelessly connect to the image processing apparatus 100 by wireless communication (more specifically, a BLE beacon or NFC). Therefore, the image processing apparatus 100 does not needs to print the connection information. On the other hand, in a case where the setting is performed using the browser 252 without using the setting application 253, since the connection information is not acquired by the wireless communication, the user U needs to read the connection information printed by the image processing apparatus 100 using the terminal device 200. In other words, in a case where the setting of the image processing apparatus 100 is performed using the browser 252, the connection information needs to be printed in advance. Therefore, the user U who wants to perform the setting of the image processing apparatus 100 using the browser 252 needs to bring the image processing apparatus 100 into a state in which the connection information can be printed before establishing a wireless connection between the terminal device 200 and the image processing apparatus 100. For this reason, in the present embodiment, the control unit 150 determines whether the image processing apparatus 100 is in a state in which it is possible to print the connection information, and thereby switches between enabling and disabling of the captive portal function described above. In other words, the control unit 150 estimates whether the user U plans to use the browser 252 or the setting application 253 to perform the setting, by determining whether the printing is possible.

Hereinafter, a configuration of the control unit 150 will be described. As illustrated in FIG. 2, the control unit 150 includes a determination section 151, a page processing section 152, an output processing section 153, and a setting reception section 154.

The determination section 151 determines whether to execute the process of the captive portal function by determining whether a predetermined condition is satisfied. In other words, the determination section 151 determines whether a predetermined condition is satisfied, and enables or disables the captive portal function depending on the determination result. In the present embodiment, specifically, the determination section 151 determines whether the printing unit 140 is in a printable state. When the printing unit 140 is in a printable state, the determination section 151 enables the captive portal function. This is because it is assumed that the user U selects the flow (that is, the flow using the browser 252) in which the printing of the connection information is necessary, not the flow (that is, the flow using the setting application 253) in which the printing of the connection information is unnecessary. On the other hand, when the printing unit 140 is not in the printable state, the determination section 151 does not enable the captive portal function. In other words, in this case, the determination section 151 disables the captive portal function. This is because it is assumed that the user U has selected a flow in which printing of the connection information is unnecessary (i.e., a flow using the setting application 253).

The determination section 151 determines whether the printing unit 140 is in a printable state, for example, depending on whether a predetermined error that hinders printing by the printing unit 140 has occurred. In other words, the determination section 151 determines that the printing unit 140 is in the printable state when the predetermined error has not occurred, and determines that the printing unit 140 is not in the printable state when the predetermined error has occurred. The predetermined error may be, for example, that a medium used for printing by the printing unit 140 is not set in the image processing apparatus 100. In this case, when the medium used for printing is not set in the image processing apparatus 100, the determination section 151 determines that the printing unit 140 is not in a printable state. In addition, the predetermined error may be that a cover that covers a part (for example, a tray or a cassette) on which the medium is set in the image processing apparatus 100 is left open. Alternatively, the ink used by the printing unit 140 for printing may be insufficient. Note that these are merely examples of the predetermined error, and the determination section 151 may determine whether the printing unit 140 is in a printable state, based on any error that hinders printing by the printing unit 140. Each of the above-described errors may be detected by a sensor provided in the image processing apparatus 100.

In the present embodiment, the captive portal function is a function for facilitating the setting of the image processing apparatus 100 using a browser. Therefore, in a case where the setting of the image processing apparatus 100 has already been completed, that is, in a case where the setting of the image processing apparatus 100 is in a state other than the initial state, the captive portal function is not necessary. Therefore, in such a case, the determination section 151 disables the captive portal function regardless of whether the printing unit 140 can perform printing. In order to realize this, the determination section 151 determines whether the setting of the image processing apparatus 100 is in the initial state. Specifically, for example, the determination section 151 determines whether the setting of the image processing apparatus 100 is in the initial state by confirming whether the setting value of each setting item remains at the initial value. In a case where the setting of the image processing apparatus 100 is in the initial state, the determination section 151 enables the direct connection function of the first wireless communication section 111 so that the wireless connection for receiving the setting instructed from the terminal device 200 can be established. In other words, in this case, the determination section 151 causes the first wireless communication section 111 to operate as an internal access point. In a case where the image processing apparatus 100 includes the second wireless communication section 112, when the setting of the image processing apparatus 100 is in the initial state and the printing unit 140 is not in the printable state, the determination section 151 enables the function of the second wireless communication section 112 to transmit the BLE beacon including the connection information.

The page processing section 152 performs processing for the captive portal function. In other words, the page processing section 152 performs processing for displaying the setting page 131 for setting the image processing apparatus 100 on the terminal device 200. More specifically, when the captive portal function is in the enabled state by the determination section 151, the page processing section 152 performs a process of displaying the setting page 131 on the terminal device 200 after the communication unit 110 establishes a wireless connection with the terminal device 200. Hereinafter, this process is also referred to as a captive portal process. The captive portal process may be referred to as a page leading process. In the present embodiment, when the printing unit 140 is in a printable state, the page processing section 152 performs the captive portal process after the communication unit 110 (specifically, the first wireless communication section 111) has established a wireless connection with the terminal device 200. In other words, when the printing unit 140 is not in a printable state, the page processing section 152 does not perform the captive portal process. The page processing section 152 specifically performs the following process as the captive portal process. The page processing section 152 transmits a redirect instruction as a response to a communication request from the terminal device 200 that has established a wireless connection with the first wireless communication section 111. The redirect instruction includes address information (specifically, URL: Uniform Resource Locator) of the setting page 131, and is an instruction for requesting the terminal device 200 to access the setting page 131.

The output processing section 153 performs output processing of various kinds of information. In the present embodiment, when the printing unit 140 is in a printable state, the output processing section 153 causes the printing unit 140 to print information to be used by the terminal device 200 to establish a wireless connection with the first wireless communication section 111 of the image processing apparatus 100. In other words, when the printing unit 140 is in a printable state, the output processing section 153 causes the printing unit 140 to print the connection information. Thus, even when the setting application 253 is not used, the terminal device 200 can acquire the connection information.

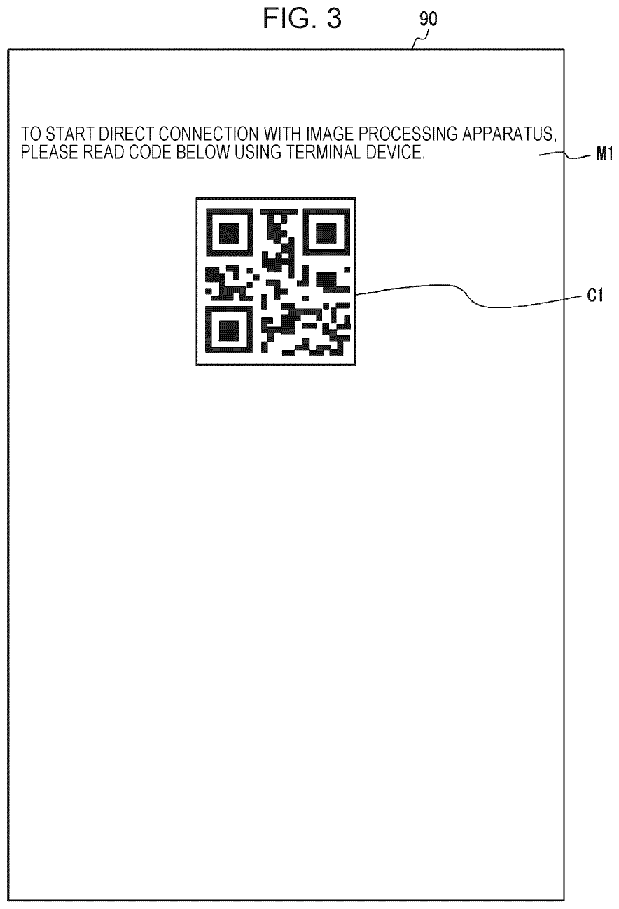

Specifically, the connection information is information including a password and an SSID of the internal access point of the image processing apparatus 100. In the present embodiment, the output processing section 153 causes the printing unit 140 to print connection information represented by a two-dimensional code such as a QR code (registered trademark). In other words, the output processing section 153 controls the printing unit 140 to print the image of the two-dimensional code representing the connection information on the medium set in the image processing apparatus 100. The output processing section 153 generates a code image obtained by encoding the connection information according to a predetermined format (for example, a format defined by the Wi-Fi Direct standard), and causes the printing unit 140 to print the code image. FIG. 3 is a diagram showing an example of printing by the printing unit 140. As illustrated in FIG. 3, on the medium 90, in addition to the message M1 for the user U, the code image C1 of the connection information is printed. By reading the code image C1, the terminal device 200 can acquire connection information for directly connecting to the image processing apparatus 100. By printing such a code image C1, it is possible to reduce the time and effort required by the user U for terminal device 200 to acquire the connection information, compared to a case where the character string of the connection information is printed.

The setting reception section 154 receives the setting of the image processing apparatus 100 instructed from the terminal device 200. In other words, the setting reception section 154 reflects the setting designated from the terminal device 200 in the image processing apparatus 100. The setting reception section 154 may receive the setting designated on the setting page 131, or may receive the setting transmitted from the terminal device 200 according to the processing of the setting application 253 of the terminal device 200. In other words, the setting reception section 154 may receive the setting instructed via the setting page 131 (the browser 252) or may receive the setting instructed via the setting application 253. The setting received by the setting reception section 154 is, for example, a network setting, but may be a setting of any function of the image processing apparatus 100 such as a printing condition.

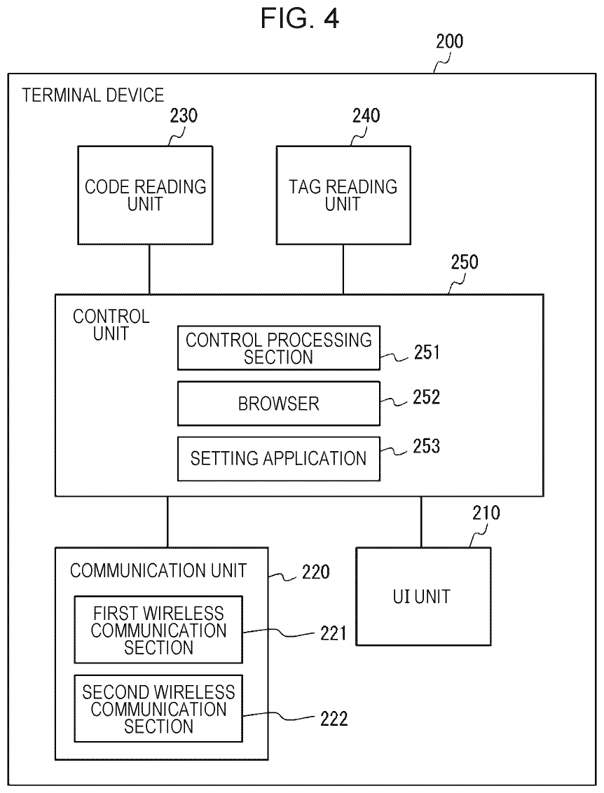

Next, the terminal device 200 will be described. The terminal device 200 is a device operated by a user U, and is, for example, a smartphone, a tablet terminal, or a personal computer. FIG. 4 is a block diagram illustrating an example of a configuration of the terminal device 200. As illustrated in FIG. 4, the terminal device 200 includes a UI unit 210, a communication unit 220, a code reading unit 230, a tag reading unit 240, and a control unit 250.

The UI unit 210 is a user interface device including an input device such as a button or a pointing device that receives an input operation from the user u, and a display. The UI unit 210 may be a touch panel in which the input device and the display are integrally configured.

The communication unit 220 is a hardware circuit that performs wireless communication with other devices according to a predetermined communication standard, and may include software such as firmware. The communication unit 220 includes a first wireless communication section 221 and a second wireless communication section 222.

The first wireless communication section 221 is a circuit that performs communication according to a first wireless communication standard. Specifically, the first wireless communication section 221 performs wireless communication according to the Wi-Fi standard. In the present embodiment, the first wireless communication section 221 performs wireless communication according to the Wi-Fi Direct standard. In other words, the first wireless communication section 221 performs direct connection to the image processing apparatus 100. The first wireless communication section 221 establishes a direct connection according to control processing by a control processing section 251, which will be described later. Specifically, the first wireless communication section 221 transmits a connection request to the image processing apparatus 100 by using connection information for directly connecting to the image processing apparatus 100. Upon receiving the connection request accompanied by the appropriate connection information, the first wireless communication section 111 of the image processing apparatus 100 establishes a direct connection with the terminal device 200.

The second wireless communication section 222 is a circuit that performs communication according to a second wireless communication standard. Specifically, the second wireless communication section 222 performs wireless communication according to the BLE standard. In the present embodiment, the second wireless communication section 222 receives a BLE beacon compliant with the BLE standard. Therefore, the second wireless communication section 222 can receive the BLE beacon that includes the connection information and that is transmitted by the second wireless communication section 112 of the image processing apparatus 100.

The code reading unit 230 is a reader that reads a code image such as a QR code. The code reading unit 230 may include a scanner or a camera as hardware for reading. The code reading unit 230 decodes the scanned or captured code image and reads the information represented by the code image. Therefore, the code reading unit 230 can read the code image of the connection information printed by the image processing apparatus 100.

The tag reading unit 240 is a reader that reads information stored in an IC chip by short-range communication, and is specifically an NFC reader. The tag reading unit 240 establishes communication with the short-range communication tag 120 using the NFC technology, and reads information stored in the short-range communication tag 120 by receiving the information stored in the short-range communication tag 120. Therefore, the tag reading unit 240 can read the connection information stored in the short-range communication tag 120 of the image processing apparatus 100.

In the example illustrated in FIG. 4, the terminal device 200 includes the second wireless communication section 222, the code reading unit 230, and the tag reading unit 240, but the terminal device 200 may not necessarily include all of these units. In other words, in the present embodiment, the connection information may be acquired by any one of the second wireless communication section 222, the code reading unit 230, and the tag reading unit 240. However, when the setting of the image processing apparatus 100 is performed by the setting application 253, the terminal device 200 includes one or both of the second wireless communication section 222 and the tag reading unit 240. In a case where the setting of the image processing apparatus 100 is performed via the browser 252 (setting page 131), the terminal device 200 includes the code reading unit 230.

The control unit 250 controls the operation of the terminal device 200. As illustrated in FIG. 4, the control unit 250 includes the control processing section 251, a browser 252, and a setting application 253.

The control processing section 251 controls the entire terminal device 200. Specifically, the control processing section 251 is an operating system (OS). In the present embodiment, when the terminal device 200 acquires connection information for a direct connection, the control processing section 251 executes a process for establishing a direct connection with the image processing apparatus 100 using the acquired connection information. Further, when the terminal device 200 receives a redirect instruction from the image processing apparatus 100, the control processing section 251 causes the first wireless communication section 221 to transmit a page request for a page specified by address information included in the redirect instruction, and activates the browser 252 for viewing the page. Upon receiving the page request from the terminal device 200, the page processing section 152 of the image processing apparatus 100 transmits data of the setting page 131 to the terminal device 200. Accordingly, the browser 252 of the terminal device 200 displays the setting page 131 on the UI unit 210.

The browser 252 is any software capable of viewing the setting page 131. In other words, the browser 252 is a general-purpose browser (Web browser). In the present embodiment, the browser 252 acquires the setting page 131 via the direct connection established between the image processing apparatus 100 and the terminal device 200. Then, the browser 252 transmits the setting information indicating the setting of each setting item of the image processing apparatus 100, which is input to the setting page 131 by the user U, to the image processing apparatus 100 via the direct connection. The setting information input to the setting page 131, that is, the setting information transmitted via the setting page 131 is received by the setting reception section 154 of the image processing apparatus 100, and the setting indicated in the setting information is reflected in the image processing apparatus 100.

The setting application 253 is dedicated application software developed for setting the image processing apparatus 100. In the present embodiment, first, the setting application 253 acquires connection information for directly connecting to the image processing apparatus 100 by using the second wireless communication section 222 or the tag reading unit 240.

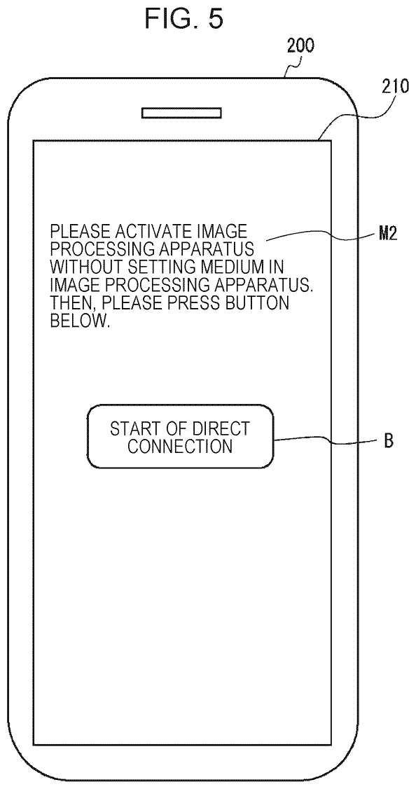

The acquisition of the connection information by the second wireless communication section 222 is realized by receiving a BLE beacon transmitted from the image processing apparatus 100 by the second wireless communication section 222. FIG. 5 is a schematic diagram illustrating an example of a screen displayed on the UI unit 210 by the setting application 253 when the setting application 253 acquires the connection information using the second wireless communication section 222. In the example shown in FIG. 5, a message M2 for the user U and a button B, which is a GUI component for instructing the start of direct connection process, are displayed. When the button B is pressed by the user U, the setting application 253 starts a process for receiving the BLE beacon transmitted from the image processing apparatus 100 by the second wireless communication section 222. As described above, the image processing apparatus 100 determines whether to enable the captive portal function depending on whether printing is possible. For this reason, in order to prevent the browser 252 of the terminal device 200 from being activated by the captive portal function of the image processing apparatus 100, the setting application 253 preferably displays a message M2, which includes a message prompting the user U not to set medium in the image processing apparatus 100, on the UI unit 210. This is because if the medium is not set in the image processing apparatus 100, the image processing apparatus 100 cannot execute printing, and thus the determination section 151 of the image processing apparatus 100 determines that the image processing apparatus 100 is in the unprintable state.

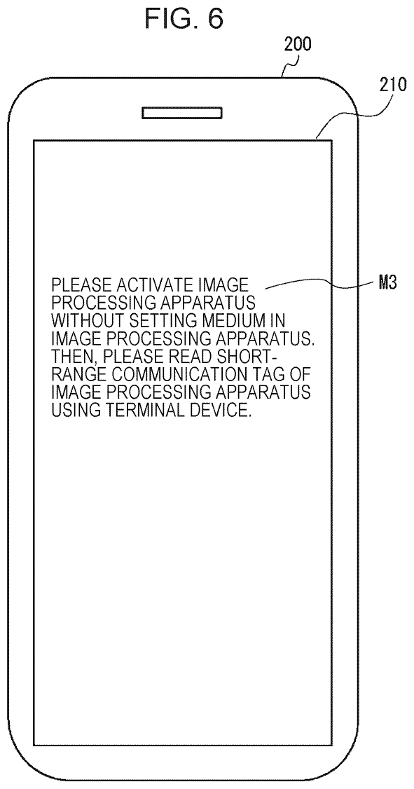

The acquisition of the connection information by the tag reading unit 240 is realized when the user U brings the terminal device 200 close to the short-range communication tag 120 of the image processing apparatus 100 and the tag reading unit 240 reads the connection information stored in the short-range communication tag 120. FIG. 6 is a schematic diagram illustrating an example of a screen displayed on the UI unit 210 by the setting application 253 when the setting application 253 acquires the connection information using the tag reading unit 240. In the example shown in FIG. 6, a message M3 for the user U is displayed. In this case as well, the setting application 253 preferably displays a message M3, including a message prompting the user not to set medium in the image processing apparatus 100, on the UI unit 210.

Upon acquiring the connection information, the setting application 253 requests the control processing section 251 to establish a direct connection using the connection information. Thus, the terminal device 200 establishes a direct connection with the image processing apparatus 100. When the direct connection with the image processing apparatus 100 is established, the setting application 253 transmits setting information indicating a predetermined setting or setting information indicating a setting instructed by the user U for each setting item of the image processing apparatus 100 to the image processing apparatus 100 via the direct connection. In other words, the setting application 253 may automatically transmit predetermined setting information to the image processing apparatus 100, or may transmit setting information based on an instruction of the user U to the image processing apparatus 100. The setting information transmitted by the processing of the setting application 253 is received by the setting reception section 154 of the image processing apparatus 100, and the setting indicated in the setting information is reflected in the image processing apparatus 100.

The setting application 253 may be dedicated application software developed for setting a system including the image processing apparatus 100. For example, it may be software developed to collectively perform setting of a sales management system such as a POS (point of sale) system. In other words, the setting application 253 may be a POS application or a register application.

In the example illustrated in FIG. 4, the terminal device 200 includes the setting application 253, but the terminal device 200 of the user U who wants to perform the setting of the image processing apparatus 100 without using the setting application 253 may not necessarily include the setting application 253.

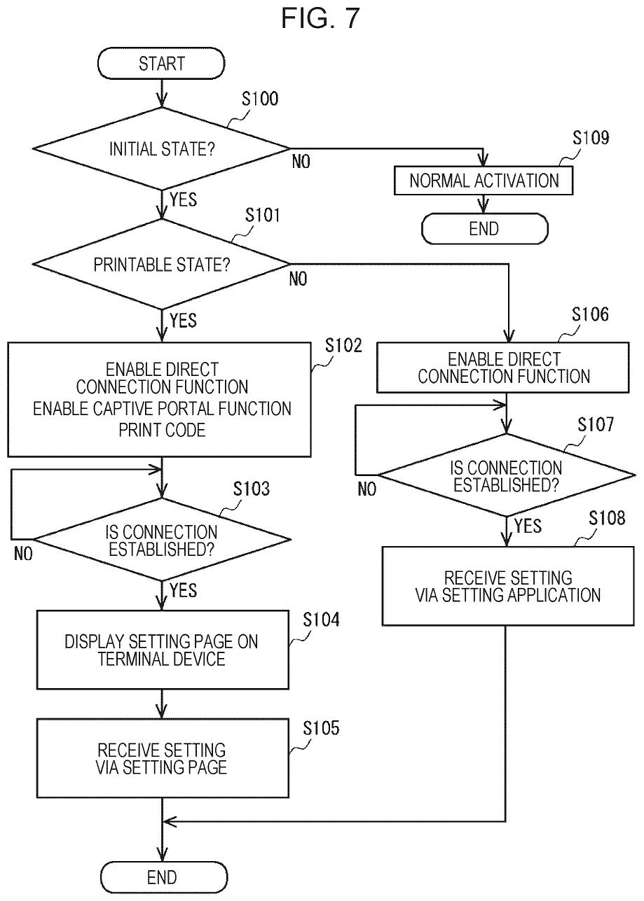

Next, a flow of a setting operation of the image processing apparatus 100 according to the present embodiment will be described. FIG. 7 is a flowchart illustrating an example of processing flow of the image processing apparatus 100. Hereinafter, the flow of the setting operation of the image processing apparatus 100 will be described with reference to FIG. 7. It should be noted that the flowchart shown in FIG. 7 is merely an example, and various modifications are possible as long as no technical contradiction occurs.

When the image processing apparatus 100 is activated, the process of step S100 is performed. In step S100, the determination section 151 of the image processing apparatus 100 determines whether the setting of the image processing apparatus 100 is in the initial state. If the settings are not in the initial state, that is, if settings appropriate for the user U have already been made (NO in step S100), the process proceeds to step S109. In step S109, the image processing apparatus 100 is normally activated. In this case, the determination section 151 does not enable the direct connection function or the captive portal function. In other words, both the direct connection function and the captive portal function are disabled. In a case where the setting is in the initial state, that is, in a case where it is necessary to perform the setting suitable for the user U (YES in step S100), the process proceeds to step S101.

In step S101, the determination section 151 determines whether the printing unit 140 is in a printable state. If the printing unit 140 is in a printable state (YES in step S101), the process proceeds to step S102. On the other hand, when the printing unit 140 is not in a printable state (NO in step S101), the process proceeds to step S106. For example, when the user U sets medium in the image processing apparatus 100 at the time of performing the setting of the image processing apparatus 100, the determination section 151 determines that the printing unit 140 is in a printable state, and the process proceeds to step S102. In a case where the user U performs the settings of the image processing apparatus 100 using the browser 252, that is, in a case where the user U performs the settings of the image processing apparatus 100 without using the setting application 253, the user U sets a medium in the image processing apparatus 100. On the other hand, when the user U wants to perform the settings of the image processing apparatus 100 using the setting application 253, the user U does not set a medium in the image processing apparatus 100. In this case, the process proceeds to step S106.

When the process proceeds to step S102, the determination section 151 enables the direct connection function of the first wireless communication section 111 so that the wireless connection for receiving the setting instructed from the terminal device 200 can be established. Further, the determination section 151 enables the captive portal function in order to facilitate setting of the image processing apparatus 100 using the browser 252. As shown in FIG. 3, the output processing section 153 causes the printing unit 140 to print the code image of the connection information. After step S102, the process proceeds to step S103.

In step S103, the image processing apparatus 100 stands by for a connection request from the terminal device 200. The user U who wants to perform setting of the image processing apparatus 100 using the browser 252 performs an operation of reading the code image printed in step S102 by the code reading unit 230 of the terminal device 200. When the code reading unit 230 reads the code image of the connection information printed by the image processing apparatus 100, the control processing section 251 of the terminal device 200 executes a process for establishing a direct connection with the image processing apparatus 100 using the acquired connection information. Upon receiving a connection request with appropriate connection information from the terminal device 200, the first wireless communication section 111 of the image processing apparatus 100 establishes a direct connection with the terminal device 200. When the direct connection is established (YES in step S103), the process proceeds to step S104.

Since the captive portal function is enabled, in step S104, the page processing section 152 performs a process of displaying the setting page 131 on the terminal device 200. In the terminal device 200, the control processing section 251 performs a process for transmitting a page request and activates the browser 252 for viewing the page. Then, the browser 252 displays the setting page 131.

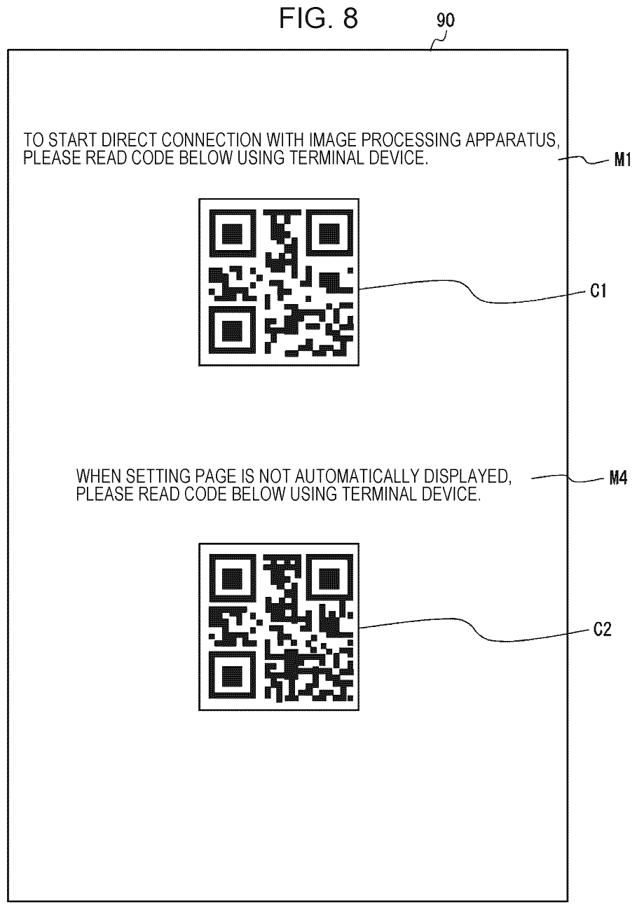

Depending on the operating system of the terminal device 200, even when the page processing section 152 performs the process of displaying the setting page 131 on the terminal device 200, the browser 252 may not be automatically activated in the terminal device 200, and the setting page 131 may not be automatically displayed. Therefore, in the above-described step S102, the output processing section 153 may cause the printing unit 140 to print not only the connection information for direct connection but also the address information of the setting page 131. Accordingly, the user U or the terminal device 200 can grasp the address information of the setting page 131. Therefore, the user U can view the setting page 131 using the browser 252. FIG. 8 is a diagram illustrating an example of printing by the printing unit 140. As shown in FIG. 8, not only the code image C1 of the connection information but also the code image C2 of the address information of the setting page 131 may be printed on the medium 90. In this case, the output processing section 153 generates a code image C2 in which the address information of the setting page 131 is encoded, and causes the printing unit 140 to print the code image C2. In the example shown in FIG. 8, a message M4 for informing the user U about the conditions under which the code image C2 is necessary is also printed. When the code image C2 of the printed address information is read by the code reading unit 230, the control processing section 251 causes the first wireless communication section 221 to transmit a page request for requesting a page specified by the address information, and activates the browser 252 for viewing the page. Therefore, even when the automatic display of the setting page 131 based on the captive portal function is not performed at the time point when the direct connection is established, the setting page 131 can be displayed using the browser 252. In order to save the user U the trouble of inputting the address information to the browser 252, the address information is preferably printed as a code image, but a character string of the address information may also be printed.

The user U performs various settings related to the image processing apparatus 100 by performing an input operation on the setting page 131 displayed by the browser 252 of the terminal device 200. As a result, in step S105, the setting reception section 154 of the image processing apparatus 100 receives the setting designated on the setting page 131. Then, the setting reception section 154 reflects the received setting in the image processing apparatus 100. Thus, the setting of the image processing apparatus 100 using the browser 252 is completed.

On the other hand, when the printing unit 140 is not in a printable state, the following process is performed in step S106. The determination section 151 enables the direct connection function of the first wireless communication section 111 so that the wireless connection for receiving the setting instructed from the terminal device 200 can be established. However, the determination section 151 does not enable the captive portal function. In other words, the determination section 151 disables the captive portal function. In addition, the output processing section 153 does not execute the printing process of the code image of the connection information. If the image processing apparatus 100 includes the second wireless communication section 112, the determination section 151 enables the function of transmitting the BLE beacon including the connection information in this step. Thus, the transmission of the BLE beacon is started. After step S106, the process proceeds to step S107.

In step S107, the image processing apparatus 100 stands by for a connection request from the terminal device 200. The user U, who wants to perform the setting of the image processing apparatus 100 using the setting application 253, activates the setting application 253. Then, under the control of the setting application 253, the second wireless communication section 222 or the tag reading unit 240 acquires the connection information from the image processing apparatus 100. When the connection information is acquired, the setting application 253 requests the control processing section 251 to establish a direct connection using the connection information. Thus, in the terminal device 200, a process for establishing a direct connection with the image processing apparatus 100 is executed. Upon receiving a connection request with appropriate connection information from the terminal device 200, the first wireless communication section 111 of the image processing apparatus 100 establishes a direct connection with the terminal device 200. When the direct connection is established (YES in step S107), the process proceeds to step S108. Since the captive portal function is not enabled in step S106, even when the direct connection between the image processing apparatus 100 and the terminal device 200 is established, the browser 252 is not activated on the terminal device 200 during the execution of the processing by the setting application 253.

When the direct connection is established, the setting application 253 transmits a predetermined setting or a setting instructed by the user U for each setting item of the image processing apparatus 100 to the image processing apparatus 100. As a result, in step S108, the setting reception section 154 of the image processing apparatus 100 receives the setting transmitted via the setting application 253. Then, the setting reception section 154 reflects the received setting in the image processing apparatus 100. Thus, the setting of the image processing apparatus 100 using the setting application 253 is completed.

The first embodiment has been described above. According to the image processing apparatus 100, when the printing unit 140 is in the printable state, the captive portal process is performed upon the establishment of the direct connection, but when the printing unit 140 is not in the printable state, the captive portal process is not performed. Therefore, in a case where the setting of the image processing apparatus 100 is performed without requiring printing by the printing unit 140, it is possible to prevent the captive portal process from being executed. In other words, in a case where the setting of the image processing apparatus 100 is performed using the setting application 253, it is possible to prevent the browser 252 from being automatically activated on the terminal device 200. Therefore, the present embodiment can improve convenience for the user U who wants to perform the setting by using the setting application 253. On the other hand, for the user U who wants to establish the direct connection by causing the terminal device 200 to read the printed connection information to perform the setting on the setting page 131, the automatic display of the setting page 131 according to the captive portal process is performed, and thus improving convenience.

### Second Embodiment

The present embodiment is different from the first embodiment in that a button provided on the image processing apparatus is also used to enable or disable the captive portal function. In the first embodiment, when the user U who wants to perform settings of the image processing apparatus 100 by using the setting application 253 erroneously performs an activation operation of the image processing apparatus in a printable state (for example, a state in which a medium is set in the image processing apparatus), the captive portal function is enabled. Therefore, the convenience for the user U, who wants to perform the setting of the image processing apparatus 100 by using the setting application 253, may be reduced. On the other hand, in the present embodiment, even when the activation operation of the image processing apparatus is performed in a state in which the image processing apparatus can perform printing, the captive portal function can be disabled by the operation of the button. Therefore, in the present embodiment, it is possible to suppress a decrease in convenience of the user U who wants to perform the setting of the image processing apparatus 100 using the setting application 253.

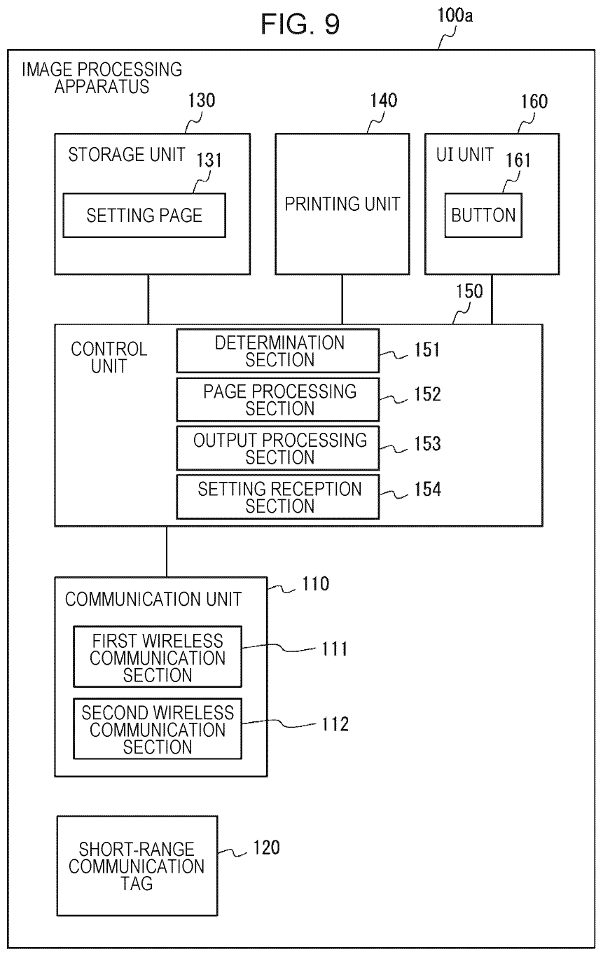

FIG. 9 is a block diagram illustrating an example of a configuration of the image processing apparatus 100a according to the second embodiment. As shown in FIG. 9, the image processing apparatus 100a is different from the image processing apparatus 100 according to the first embodiment in that the image processing apparatus 100a further includes a UI unit 160. This does not exclude that the image processing apparatus 100 according to the first embodiment includes the UI unit 160. Hereinafter, features different from those of the image processing apparatus 100 according to the first embodiment will be described, and overlapping description will be appropriately omitted.

The UI unit 160 is a component that functions as a user interface, and includes at least a button 161 that can be operated by the user U in the present embodiment. The UI unit 160 may include other user interfaces such as a display and a speaker.

Also in the present embodiment, the determination section 151 of the image processing apparatus 100a determines whether a predetermined condition is satisfied, and enables or disables the captive portal function depending on the determination result. However, in the present embodiment, the determination section 151 not only determines whether the printing unit 140 is in a printable state, but also determines whether the button 161 has been operated. Similarly to the first embodiment, the determination section 151 according to the present embodiment enables the captive portal function when the printing unit 140 is in a printable state. However, if the button 161 is operated afterward before the communication unit 110 establishes a wireless connection with the terminal device 200, the determination section 151 disables the captive portal function. Also in the present embodiment, when the printing unit 140 is not in a printable state, the determination section 151 does not enable the captive portal function.

Based on the above-described determination, in the present embodiment, the page processing section 152 operates as follows. When the printing unit 140 is in the printable state and the button 161 is not operated before the communication unit 110 establishes the wireless connection with the terminal device 200, the page processing section 152 performs the captive portal process after the communication unit 110 (specifically, the first wireless communication section 111) establishes the wireless connection with the terminal device 200. In other words, when the button 161 is operated before the communication unit 110 establishes the wireless connection with the terminal device 200, the page processing section 152 does not perform the captive portal process even when the communication unit 110 establishes the wireless connection with the terminal device 200.

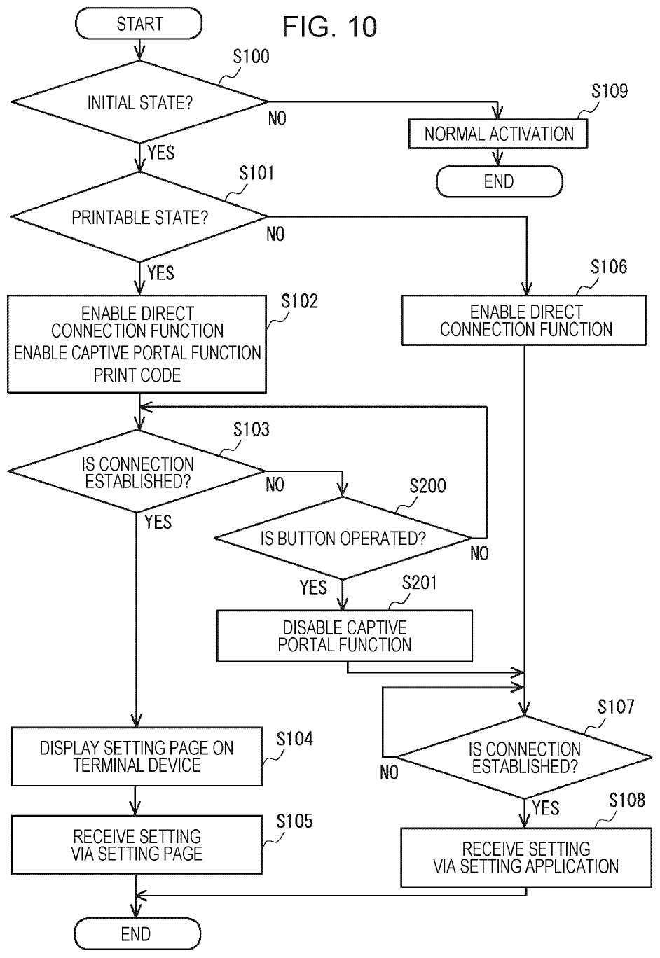

Next, a flow of a setting operation of the image processing apparatus 100a according to the second embodiment will be described. FIG. 10 is a flowchart illustrating an example of the processing flow of the image processing apparatus 100a according to the second embodiment. Hereinafter, the flow of the setting operation of the image processing apparatus 100a will be described with reference to FIG. 10. In FIG. 10, steps in which the same processes as those in the flowchart shown in FIG. 7 are performed are denoted by the same step numbers as those in FIG. 7. In addition, the flowchart illustrated in FIG. 10 is merely an example, and various modifications are possible as long as no technical contradiction occurs.

When the image processing apparatus 100a is activated, the process of step S100 is performed. In step S100, the determination section 151 of the image processing apparatus 100a determines whether the setting of the image processing apparatus 100a is in the initial state. When the setting is not in the initial state (NO in step S100), the process proceeds to step S109. In step S109, the image processing apparatus 100a is normally activated. In this case, the determination section 151 does not enable the direct connection function or the captive portal function. When the setting is in the initial state (YES in step S100), the process proceeds to step S101.

In step S101, the determination section 151 determines whether the printing unit 140 is in a printable state. If the printing unit 140 is in a printable state (YES in step S101), the process advances to step S102. On the other hand, when the printing unit 140 is not in a printable state (NO in step S101), the process proceeds to step S106.

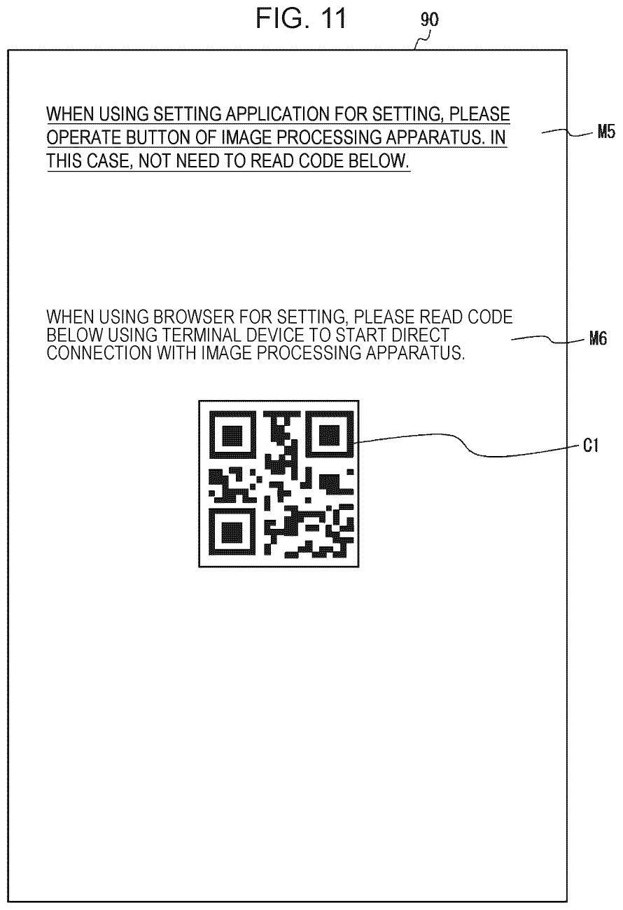

When the process proceeds to step S102, the determination section 151 enables the captive portal function and the direct connection function of the first wireless communication section 111. Further, the output processing section 153 causes the printing unit 140 to print the code image of the connection information. The output processing section 153 may output a notification for prompting the user U, who performs the setting of the image processing apparatus 100a without using the setting page 131 (that is, the browser 252) (that is, the user U who wants to perform the setting by using the setting application 253), to operate the button 161. As a result, since it is possible to prompt the user U who wants to perform the setting using the setting application 253 to operate the button 161, it is possible to more reliably improve the convenience of the user U. Specifically, the output processing section 153 may perform printing as illustrated in FIG. 11 instead of the printing illustrated in FIG. 3. FIG. 11 is a diagram illustrating an example of printing by the printing unit 140. As illustrated in FIG. 11, for the user U who performs the setting of the image processing apparatus 100a without using the setting page 131, a message M5 prompting the user U to operate the button 161 is also printed on the medium 90. In the example illustrated in FIG. 11, a message M6 is also printed to notify that the user who should use the code image C1 of the connection information is the user who wants to perform the setting of the image processing apparatus 100a using the browser 252 (setting page 131). As illustrated in FIG. 8, the code image C2 of the address information of the setting page 131 may be further printed on the medium 90. Further, the output processing section 153 may not necessarily output the notification represented by the message M5 or the message M6 by printing. For example, in a case where the UI unit 160 includes a speaker, the notification may be output by voice. In a case where the UI unit 160 includes a display, the notification may be output as a display on the display.

After step S102, the process proceeds to step S103. In step S103, the image processing apparatus 100a stands by for a connection request from the terminal device 200. In the flowchart shown in FIG. 7, step S103 is repeated until the direct connection is established, but in the flowchart shown in FIG. 10, when the direct connection is not established (NO in step S103), the process proceeds to step S200.

In step S200, the determination section 151 determines whether the button 161 is operated. If the button 161 has not been operated (NO in step S200), the process returns to step S103. On the other hand, when the button 161 is operated (YES in step S200), the process proceeds to step S201. The user U who wants to perform the setting of the image processing apparatus 100a using the setting application 253 operates the button 161 before establishing a direct connection using the setting application 253.

In step S201, the determination section 151 disables the enabled captive portal function. After step S201, the process proceeds to step S107.

If the direct connection is established without the button 161 being operated (YES in step S103), the process proceeds to step S104. The user U who wants to perform the setting of the image processing apparatus 100a using the browser 252 performs an operation of reading the code image printed in step S102 by the code reading unit 230 of the terminal device 200 without operating the button 161. Thus, a direct connection is established between the image processing apparatus 100a and the terminal device 200.

Since the captive portal function remains enabled, in step S104, the page processing section 152 performs a process of displaying the setting page 131 on the terminal device 200. The user U performs various settings related to the image processing apparatus 100a by performing an input operation on the setting page 131 displayed by the browser 252 of the terminal device 200. As a result, in step S105, the setting reception section 154 of the image processing apparatus 100a receives the setting designated on the setting page 131. Then, the setting reception section 154 reflects the received setting in the image processing apparatus 100a. Thus, the setting of the image processing apparatus 100a using the browser 252 is completed.

On the other hand, when the printing unit 140 is not in the printable state, in step S106, the determination section 151 enables the direct connection function of the first wireless communication section 111, but does not enable the captive portal function. In addition, the output processing section 153 does not execute the printing process of the code image of the connection information. If the image processing apparatus 100a includes the second wireless communication section 112, the determination section 151 enables the function of transmitting the BLE beacon including the connection information in this step. Thus, the transmission of the BLE beacon is started. After step S106, the process proceeds to step S107. In the present embodiment, as described above, also in a case where the button 161 is operated, the process proceeds to step S107 after the once enabled captive portal function is disabled.

In step S107, the image processing apparatus 100a stands by for a connection request from the terminal device 200. The user U who wants to perform the setting of the image processing apparatus 100a using the setting application 253 activates the setting application 253. Thus, a direct connection is established between the image processing apparatus 100a and the terminal device 200. When the direct connection is established (YES in step S107), the process proceeds to step S108. Since the captive portal function is not enabled in step S106 or is disabled in step S201, even when a direct connection is established between the image processing apparatus 100a and the terminal device 200, the browser 252 is not activated in the terminal device 200 during the execution of the processing by the setting application 253.

When the direct connection is established, the setting application 253 transmits a predetermined setting or a setting instructed by the user U for each setting item of the image processing apparatus 100a to the image processing apparatus 100a. As a result, in step S108, the setting reception section 154 of the image processing apparatus 100a receives the setting transmitted via the setting application 253. Then, the setting reception section 154 reflects the received setting in the image processing apparatus 100a. Thus, the setting of the image processing apparatus 100a using the setting application 253 is completed.

The second embodiment has been described above. In the present embodiment, even when the activation operation is performed in a state where the image processing apparatus 100a can perform printing, the captive portal function can be disabled by the operation of the button 161. For this reason, in the present embodiment, it is possible to suppress a decrease in convenience of the user U who wants to perform the setting of the image processing apparatus 100a using the setting application 253.

### Modification of Second Embodiment

Next, a modification of the second embodiment will be described. Also in the present modification, the button 161 provided on the image processing apparatus 100a is used to enable or disable the captive portal function. In the second embodiment, the once enabled captive portal function is disabled by the operation of the button 161. On the other hand, in the present modification, when the button 161 is not operated for a predetermined time, the captive portal function is enabled. Hereinafter, features different from those of the image processing apparatus 100a according to the second embodiment will be described, and overlapping description will be appropriately omitted.

Also in the present modification, the determination section 151 determines not only whether the printing unit 140 is in a printable state but also whether the button 161 has been operated. The determination section 151 according to the present modification does not immediately enable the captive portal function even when the printing unit 140 is in a printable state. In other words, even when the printing unit 140 is in a printable state, the determination section 151 does not enable the captive portal function until a predetermined standby time elapses without the button 161 being operated. In other words, the determination section 151 enables the captive portal function if the button 161 is not operated before the predetermined standby time elapses after it is determined that the printing unit 140 is in the printable state. Also in the present modification, the determination section 151 does not enable the captive portal function when the printing unit 140 is not in a printable state.

Based on the above-described determination, in the present modification, the page processing section 152 operates as follows. In a case where the printing unit 140 is in a printable state and the button 161 is not operated before a predetermined standby time elapses, the page processing section 152 of the present modification performs the captive portal process after the communication unit 110 (specifically, the first wireless communication section 111) establishes a wireless connection with the terminal device 200. In other words, in a case where the button 161 is operated before the predetermined standby time elapses, the captive portal process is not performed even when the communication unit 110 establishes the wireless connection with the terminal device 200.

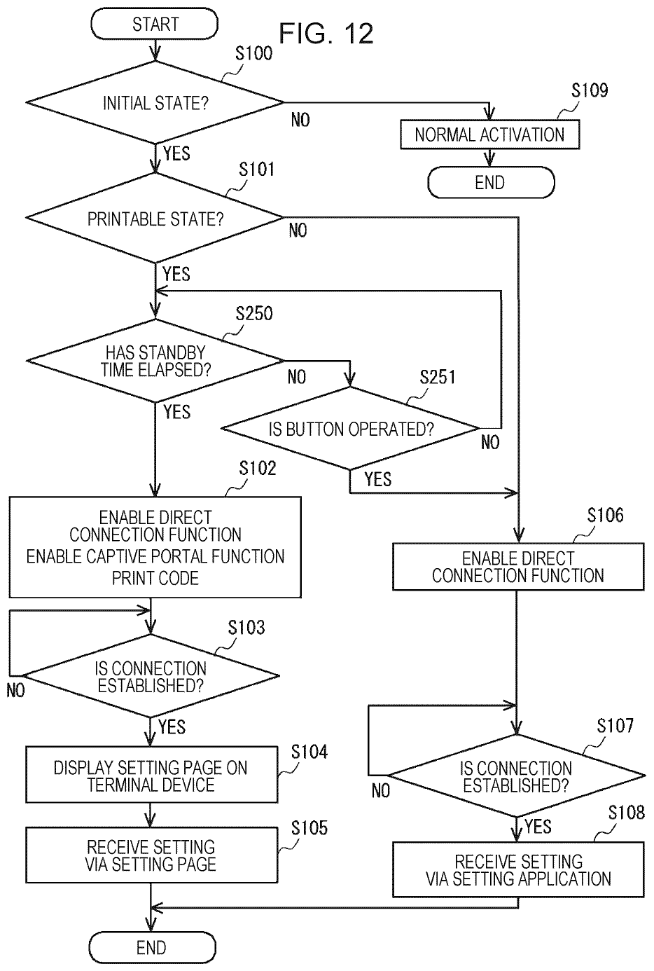

Next, a flow of a setting operation of the image processing apparatus 100a according to the modification will be described. FIG. 12 is a flowchart illustrating an example of a flow of process performed by the image processing apparatus 100a according to the modification. Hereinafter, the flow of the setting operation of the image processing apparatus 100a according to the modification will be described with reference to FIG. 12. In FIG. 12, step in which the same processes as those in the flowchart shown in FIG. 7 are performed are denoted by the same step number as those in FIG. 7. In addition, the flowchart illustrated in FIG. 12 is merely an example, and various modifications are possible as long as no technical contradiction occurs.

When the image processing apparatus 100a is activated, the process of step S100 is performed. In step S100, the determination section 151 of the image processing apparatus 100a determines whether the setting of the image processing apparatus 100a is in the initial state. When the setting is not in the initial state (NO in step S100), the process proceeds to step S109. In step S109, the image processing apparatus 100a is normally activated. In this case, the determination section 151 does not enable the direct connection function or the captive portal function. When the setting is in the initial state (YES in step S100), the process proceeds to step S101.

In step S101, the determination section 151 determines whether the printing unit 140 is in a printable state. In the present modification, if the printing unit 140 is in a printable state (YES in step S101), the process proceeds to step S250. On the other hand, when the printing unit 140 is not in a printable state (NO in step S101), the process proceeds to step S106. In a case where the printing unit 140 is in a printable state, the output processing section 153 may output a notification for prompting the user U, who performs the setting of the image processing apparatus 100a without using the setting page 131 (that is, the browser 252) (that is, the user U who wants to perform the setting using the setting application 253), to operate the button 161. In addition, the output processing section 153 may output the notification by printing. However, in a case where the UI unit 160 includes a speaker, the notification may be output by voice, and in a case where the UI unit 160 includes a display, the notification may be output as a display on the display. As a result, since it is possible to prompt the user U who wants to perform the setting using the setting application 253 to operate the button 161, it is possible to more reliably improve the convenience of the user U.

When the process proceeds to step S250, the determination section 151 determines whether a predetermined standby time has elapsed. When the predetermined standby time has not elapsed (NO in step S250), the process proceeds to step S251. On the other hand, when the predetermined standby time has elapsed (YES in step S250), the process proceeds to step S102.

In step S251, the determination section 151 determines whether the button 161 is operated. If the button 161 has not been operated (NO in step S251), the process returns to step S250. On the other hand, when the button 161 is operated (YES in step S251), the process proceeds to step S106. The user U, who wants to perform the setting of the image processing apparatus 100a using the setting application 253, operates the button 161 before a predetermined standby time elapses.

When the standby time has elapsed without the button 161 being operated and the process has proceeded to step S102, the determination section 151 enables the captive portal function and the direct connection function of the first wireless communication section 111. Further, the output processing section 153 causes the printing unit 140 to print the code image of the connection information. The output processing section 153 may cause the printing unit 140 to print not only the code image of the connection information but also a code image of the address information of the setting page 131.

After step S102, the process proceeds to step S103. In step S103, the image processing apparatus 100a stands by for a connection request from the terminal device 200. If a direct connection has been established (YES in step S103), the process proceeds to step S104. The user U, who wants to perform the setting of the image processing apparatus 100a using the browser 252, performs an operation of reading the code image printed in step S102 by the code reading unit 230 of the terminal device 200. Thus, a direct connection is established between the image processing apparatus 100a and the terminal device 200.

Since the captive portal function is enabled, in step S104, the page processing section 152 performs a process of displaying the setting page 131 on the terminal device 200. The user U performs various settings related to the image processing apparatus 100a by performing an input operation on the setting 200. As a result, in step S105, the setting reception section 154 of the image processing apparatus 100a receives the setting designated on the setting page 131. Then, the setting reception section 154 reflects the received setting in the image processing apparatus 100a. Thus, the setting of the image processing apparatus 100a using the browser 252 is completed.

On the other hand, if the printing unit 140 is not in a printable state (NO in step S101), or if the button 161 has been operated (YES in step S251), the determination section 151 enables the direct connection function of the first wireless communication section 111 in step S106. However, the determination section 151 does not enable the captive portal function. In addition, the output processing section 153 does not execute the printing process of the code image of the connection information. If the image processing apparatus 100a includes the second wireless communication section 112, the determination section 151 enables the function of transmitting the BLE beacon including the connection information in this step. Thus, the transmission of the BLE beacon is started. After step S106, the process proceeds to step S107.

In step S107, the image processing apparatus 100a stands by for a connection request from the terminal device 200. The user U who wants to perform the setting of the image processing apparatus 100a using the setting application 253 activates the setting application 253. Thus, a direct connection is established between the image processing apparatus 100a and the terminal device 200. When the direct connection is established (YES in step S107), the process proceeds to step S108. Since the captive portal function is not enabled in step S106, even when the direct connection between the image processing apparatus 100a and the terminal device 200 is established, the browser 252 is not activated in the terminal device 200 during the execution of the processing by the setting application 253.

When the direct connection is established, the setting application 253 transmits a predetermined setting or a setting instructed by the user U for each setting item of the image processing apparatus 100a to the image processing apparatus 100a. As a result, in step S108, the setting reception section 154 of the image processing apparatus 100a receives the setting transmitted via the setting application 253. Then, the setting reception section 154 reflects the received setting in the image processing apparatus 100a. Thus, the setting of the image processing apparatus 100a using the setting application 253 is completed.

The modification of the second embodiment has been described above. Also in the present modification, even when the activation operation is performed in a state in which the image processing apparatus 100a can perform printing, the captive portal function can be disabled by the operation of the button 161. Therefore, also in the present modification, it is possible to suppress a decrease in convenience of the user U who wants to perform the setting of the image processing apparatus 100a by using the setting application 253.

Although the second embodiment and the modifications thereof have been described, the timing of the operation of the button 161 for disabling the captive portal function is not limited to the timing shown in the specific example described above. Therefore, the determination section 151 may enable the captive portal function when the printing unit 140 is in a printable state and the button 161 is not operated. Then, when the button 161 is operated, the captive portal may not be enabled. In other words, the page processing section 152 may perform the captive portal process after the communication unit 110 establishes the wireless connection with the terminal device 200 in the case where the printing unit 140 is in the printable state and in the and the button 161 is not operated. In a case where the button 161 is operated, the page processing section 152 may not perform the captive portal process even when the wireless connection is established.

### Third Embodiment

In the above-described embodiment, in a case where the user U who wants to perform the setting of the image processing apparatus using the setting page 131 (the browser 252) erroneously performs the activation operation of the image processing apparatus in a state where printing is not possible (for example, a state where a medium is not set in the image processing apparatus), the captive portal function cannot be enabled. Therefore, there is a concern that convenience of the user U, who wants to perform the setting of the image processing apparatus using the setting page 131, may be reduced. Therefore, in the present embodiment, a technique is disclosed in which the captive portal function can be enabled even when the image processing apparatus is activated in a state in which printing is not possible.

The image processing apparatus of the present embodiment also has the configuration of the image processing apparatus 100a shown in FIG. 9. Hereinafter, features different from those of the above-described embodiment will be described, and overlapping description will be appropriately omitted.

Even if the printing unit 140 of the image processing apparatus 100a is not in a printable state when the image processing apparatus 100a is activated, the determination section 151 of the present embodiment enables the captive portal function afterward when the printing unit 140 is brought into a printable state thereafter. Hereinafter, the present embodiment will be described in detail with reference to a flowchart.

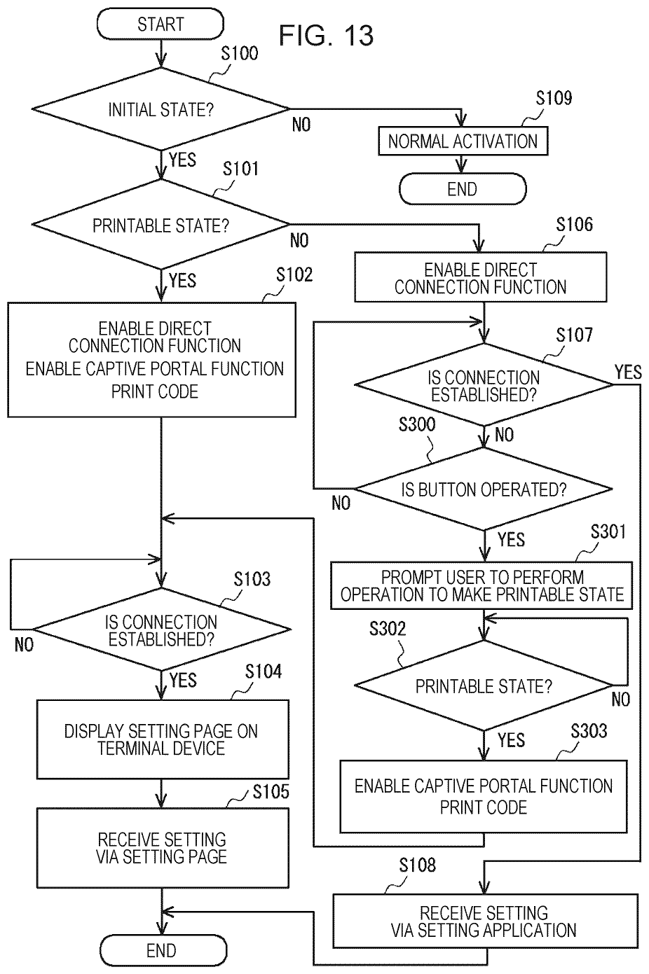

FIG. 13 is a flowchart illustrating an example of the flow of process performed by the image processing apparatus 100a according to the third embodiment. In FIG. 13, steps in which the same processes as those in the flowchart shown in FIG. 7 are performed are denoted by the same step numbers as those in FIG. 7. In addition, the flowchart illustrated in FIG. 13 is merely an example, and various modifications are possible as long as no technical contradiction occurs.

When the image processing apparatus 100a is activated, the process of step S100 is performed. Since the flow of the operation from step S100 to step S105 is the same as that in FIG. 7, the description thereof will be omitted. Also in the present embodiment, when the setting is not in the initial state (NO in step S100), the process proceeds to step S109. Then, in step S109, the image processing apparatus 100a is normally activated.

Also in the present embodiment, when the printing unit 140 is not in a printable state immediately after the activation of the image processing apparatus 100a (NO in step S101), the process proceeds to step S106. The processing in step S106 and subsequent steps will be described in detail below.

If the printing unit 140 is not in a printable state, the following processing is performed in step S106 in the present embodiment as well. In other words, the determination section 151 enables the direct connection function of the first wireless communication section 111, but does not enable the captive portal function. In other words, the determination section 151 disables the captive portal function. In addition, the output processing section 153 does not execute the printing process of the code image of the connection information. If the image processing apparatus 100a includes the second wireless communication section 112, the determination section 151 enables the function of transmitting the BLE beacon including the connection information in this step. Thus, the transmission of the BLE beacon is started. After step S106, the process proceeds to step S107.

In step S107, the image processing apparatus 100a stands by for a connection request from the terminal device 200. In the flowchart shown in FIG. 7, step S107 is repeated until the direct connection is established, but in the flowchart of the present embodiment, when the direct connection is not established (NO in step S107), the process proceeds to step S300. When the direct connection is established, as in the other embodiments, in step S108, the setting reception section 154 receives the setting transmitted via the setting application 253, and the setting is reflected in the image processing apparatus 100a.

When the process proceeds to step S300, the determination section 151 determines whether the button 161 is operated. If the button 161 has not been operated (NO in step S300), the process returns to step S107. On the other hand, when the button 161 is operated (YES in step S300), the process proceeds to step S301. The user U, who wants to perform the setting of the image processing apparatus 100a using the setting page 131 (the browser 252), operates the button 161 before establishing a direct connection using the setting application 253. In order to prompt the user U to perform the button operation, the output processing section 153 may output a notification for prompting the user U to perform the operation of the button 161 for the user U who performs the setting of the image processing apparatus 100a using the setting page 131 (that is, the browser 252) in advance (for example, in step S106). When the UI unit 160 includes a speaker, the output processing section 153 can output the notification by voice. Further, when the UI unit 160 includes a display, the output processing section 153 can output the notification as a display on the display.

When the operation of the button 161 is performed, in step S301, the output processing section 153 outputs a notification that prompts the user U to perform an operation for bringing the printing unit 140 into a printable state. In other words, in a case where the button 161 is operated in a state in which the printing unit 140 is not in a printable state, the output processing section 153 outputs a notification for prompting the user U to perform an operation for bringing the printing unit 140 into a printable state. For example, the output processing section 153 outputs a notification corresponding to the reason why printing cannot be performed. Specifically, for example, in a case where printing cannot be performed due to the medium not being set in the image processing apparatus 100a, the output processing section 153 outputs a notification that prompts the user U to set the medium. In addition, for example, in a case where the output processing section 153 cannot perform printing due to a shortage of ink, the output processing section 153 outputs a notification for prompting the user U to replenish ink. In a case where the UI unit 160 includes a speaker, the output processing section 153 can output the notification by voice. Further, when the UI unit 160 includes a display, the output processing section 153 can output the notification as a display on the display. After step S301, the process proceeds to step S302.

In step S302, the determination section 151 determines whether the printing unit 140 is in a printable state. This step is repeated until the printing unit 140 is brought into a printable state. When the printing unit 140 is in a printable state (YES in step S302), the process proceeds to step S303.

When the process proceeds to step S303, the determination section 151 enables the captive portal function in order to facilitate the setting of the image processing apparatus 100 using the browser 252. Further, the output processing section 153 causes the printing unit 140 to print the code image of the connection information. The output processing section 153 may cause the printing unit 140 to print not only the code image of the connection information but also a code image of the address information of the setting page 131.

After step S303, the process proceeds to step S103, and the processes from step S103 to step S105 described with reference to the flowchart of FIG. 7 are performed. In other words, when the direct connection is established, the page processing section 152 performs the process of displaying the setting page 131 on the terminal device 200. As described above, in the present embodiment, even when the printing unit 140 is not in a printable state, if the printing unit 140 is brought into a printable state afterward, the page processing section 152 performs the captive portal process after the communication unit 110 establishes a wireless connection with the terminal device 200.

The third embodiment has been described above. In the present embodiment, even when the activation operation is performed in a state where the image processing apparatus 100a cannot perform printing, the captive portal function can be enabled. Therefore, in the present embodiment, it is possible to improve the convenience of the user U who wants to perform the setting of the image processing apparatus 100a by using the setting page 131 (browser 252). The present embodiment may be combined with the second Embodiment or the modification thereof. In other words, the flow described in the second embodiment or the modification thereof may be executed as the flow after it is determined in step S101 in FIG. 13 that printing is possible.

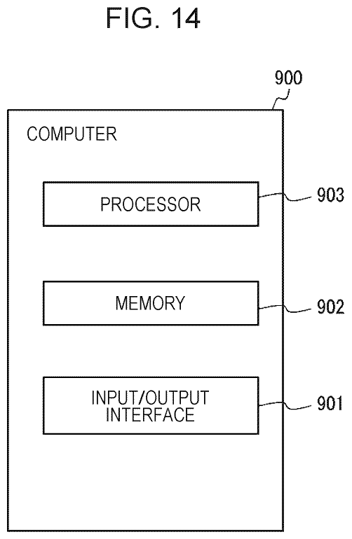

Although the embodiments and the modifications have been described above, the processes of the image processing apparatus 100 or 100a, and the terminal device 200 may be executed by a computer included in each apparatus. The computer may be configured as a SoC (System on a Chip). FIG. 14 is a block diagram illustrating an example of a hardware configuration of a computer 900 included in the image processing apparatus 100 or 100a, or the terminal device 200. As illustrated in FIG. 14, the computer 900 includes, for example, an input/output interface 901, the memory 902, and a processor 903.

The input/output interface 901 is used to communicate with any circuit or device.

The memory 902 is configured by, for example, a combination of a volatile memory and a nonvolatile memory. The memory 902 is used to store a program executed by the processor 903, data used for various processes, and the like.

The processor 903 reads and executes the program from the memory 902, thereby performing various processes described in the above-described embodiments or modifications. The processor 903 may be, for example, a microprocessor, a microprocessor unit (MPU), or a central processing unit (CPU). Further, the processor 903 may include a plurality of processors.

The program includes a group of instructions (or software code) for causing a computer to perform one or more of the functions described in the embodiments when the program is loaded into the computer. The program may be stored in a non-transitory computer-readable medium or a tangible storage medium. By way of example, and not limitation, such computer-readable medium or tangible storage medium may include a RAM (random-access memory), a ROM (read-only memory), a flash memory, a SSD (solid-state drive) or other memory technology, a CD-ROM, a DVD (digital versatile disc), a Blu-ray (registered trademark) disc or other optical disc storage, a magnetic cassette, a magnetic tape, magnetic disk storage or another magnetic storage device. Each of the programs may be transmitted on a transitory computer-readable medium or a communication medium. By way of example, and not limitation, the transitory computer-readable medium or the communication medium includes electrical, optical, acoustical or other forms of propagated signals.

Note that the present disclosure is not limited to the above-described embodiments and modifications thereof, and can be appropriately modified without departing from the spirit and scope of the present disclosure.

Some or all of the above-described embodiments and modifications may be described as in the following supplementary notes, but are not limited thereto.

### Supplementary Note 1

An image processing apparatus includes: a printing unit configured to perform printing; a communication unit configured to perform wireless communication; and a page processing section configured to perform a process of displaying a setting page for setting the image processing apparatus on a terminal device, in which the page processing section is configured to perform the process after the communication unit establishes a wireless connection with the terminal device, when the printing unit is in a printable state, and not to perform the process when the printing unit is not in the printable state.

### Supplementary Note 2

The image processing apparatus according to Supplementary note 1 further includes a button, in which the page processing section is configured to perform the process after the communication unit establishes a wireless connection with the terminal device, when the printing unit is in the printable state and the button is not operated, and not to perform the process even when the communication unit establishes a wireless connection with the terminal device when the button is operated.

### Supplementary Note 3

In the image processing apparatus according to Supplementary note 2, the page processing section is configured to perform the process after the communication unit establishes a wireless connection with the terminal device, when the printing unit is in the printable state and the button is not operated before the communication unit establishes the wireless connection with the terminal device, and not to perform the process even when the communication unit establishes a wireless connection with the terminal device, when the button is operated before the communication unit establishes the wireless connection with the terminal device.

### Supplementary Note 4

In the image processing apparatus according to Supplementary note 2, the page processing section is configured to perform the process after the communication unit establishes a wireless connection with the terminal device, when the printing unit is in the printable state and the button is not operated before a predetermined standby time elapses, and not to perform the process even when the communication unit establishes a wireless connection with the terminal device, when the button is operated before the predetermined standby time elapses.

### Supplementary Note 5

The image processing apparatus according to any one of supplementary notes 2 to 4 further includes an output processing section configured to output a notification for prompting a user, who performs a setting of the image processing apparatus without using the setting page, to operate the button, when the printing unit is in the printable state.

### Supplementary Note 6

The image processing apparatus according to any one of Supplementary notes 1 to 5 further includes: a button; and an output processing section configured to output a notification, in which the output processing section outputs a notification for prompting a user to perform an operation for bringing the printing unit into the printable state, when the button is operated in a state where the printing unit is not in the printable state, and the page processing section performs the process after the communication unit establishes a wireless connection with the terminal device, when the printing unit is in a printable state.

### Supplementary Note 7

The image processing apparatus according to any one of Supplementary notes 1 to 6 further includes an output processing section configured to cause the printing unit to print information to be used by the terminal device to establish a wireless connection with the communication unit when the printing unit is in the printable state.

### Supplementary Note 8

In the image processing apparatus according to Supplementary note 7, the output processing section further causes the printing unit to print address information of the setting page, when the printing unit is in the printable state.

### Supplementary Note 9

A processing method for an image processing apparatus includes a printing unit configured to perform printing and a communication unit configured to perform wireless communication, the processing method including: determining whether the printing unit is in a printable state; performing a process of displaying a setting page for setting the image processing apparatus on a terminal device after the communication unit establishes a wireless connection with the terminal device, when the printing unit is in the printable state; and not performing the process when the printing unit is not in the printable state.

### Supplementary Note 10

A non-transitory computer-readable storage medium stores a program causing a computer of an image processing apparatus including a printing unit configured to perform printing and a communication unit configured to perform wireless communication to execute: determining whether the printing unit is in a printable state; performing a process of displaying a setting page for setting the image processing apparatus on a terminal device after the communication unit establishes a wireless connection with the terminal device, when the printing unit is in the printable state; and not performing the process when the printing unit is not in the printable state.

What is claimed is:

1. An image processing apparatus comprising:
a printing unit configured to perform printing;
a communication unit configured to perform wireless communication; and
a page processing section configured to perform a process of displaying a setting page for setting the image processing apparatus on a terminal device, wherein
the page processing section is configured
to perform the process after the communication unit establishes a wireless connection with the terminal device, when the printing unit is in a printable state, and
not to perform the process when the printing unit is not in the printable state.

2. The image processing apparatus according to claim 1, further comprising
a button, wherein
the page processing section is configured
to perform the process after the communication unit establishes a wireless connection with the terminal device, when the printing unit is in the printable state and the button is not operated, and
not to perform the process even when the communication unit establishes a wireless connection with the terminal device when the button is operated.

3. The image processing apparatus according to claim 2, wherein
the page processing section is configured
to perform the process after the communication unit establishes a wireless connection with the terminal device, when the printing unit is in the printable state and the button is not operated before the communication unit establishes the wireless connection with the terminal device, and
not to perform the process even when the communication unit establishes a wireless connection with the terminal device, when the button is operated before the communication unit establishes the wireless connection with the terminal device.

4. The image processing apparatus according to claim 2, wherein
the page processing section is configured
to perform the process after the communication unit establishes a wireless connection with the terminal device, when the printing unit is in the printable state and the button is not operated before a predetermined standby time elapses, and
not to perform the process even when the communication unit establishes a wireless connection with the terminal device, when the button is operated before the predetermined standby time elapses.

5. The image processing apparatus according to claim 2, further comprising
an output processing section configured to output a notification for prompting a user, who performs a setting of the image processing apparatus without using the setting page, to operate the button, when the printing unit is in the printable state.

6. The image processing apparatus according to claim 1, further comprising:
a button; and
an output processing section configured to output a notification, wherein
the output processing section outputs a notification for prompting a user to perform an operation for bringing the printing unit into the printable state, when the button is operated in a state where the printing unit is not in the printable state, and
the page processing section performs the process after the communication unit establishes a wireless connection with the terminal device, when the printing unit is in a printable state.

7. The image processing apparatus according to claim 1, further comprising
an output processing section configured to cause the printing unit to print information to be used by the terminal device to establish a wireless connection with the communication unit, when the printing unit is in the printable state.

8. The image processing apparatus according to claim 7, wherein
the output processing section further causes the printing unit to print address information of the setting page, when the printing unit is in the printable state.

9. A processing method for an image processing apparatus including a printing unit configured to perform printing and a communication unit configured to perform wireless communication, the processing method comprising:
determining whether the printing unit is in a printable state;
performing a process of displaying a setting page for setting the image processing apparatus on a terminal device after the communication unit establishes a wireless connection with the terminal device, when the printing unit is in the printable state; and
not performing the process when the printing unit is not in the printable state.

10. A non-transitory computer-readable storage medium storing a program causing a computer of an image processing apparatus including a printing unit configured to perform printing and a communication unit configured to perform wireless communication to execute:
determining whether the printing unit is in a printable state;
performing a process of displaying a setting page for setting the image processing apparatus on a terminal device after the communication unit establishes a wireless connection with the terminal device, when the printing unit is in the printable state; and
not performing the process when the printing unit is not in the printable state.
